(19) United States
(12) Patent Application Publication
(10) Pub. No.: US 2006/0242341 A1
(43) Pub. Date: Oct. 26, 2006

(54) Control system with two hosts

(75) Inventors: Cheng-Hsien Tsai, Tainan City (TW); Ho-Chang Lee, Taipei (TW); Te-Chen Liao, Taipei City (TW); Cheng-Chung Kuo, Taipei City (TW)

Correspondence Address: GENUS LAW GROUP PLLC, BOX 26219, CRYSTAL CITY STATION, VA, 22215, US

(73) Assignee: SILICON INTEGRATED SYSTEMS CORP.

(21) Appl. No.: 11/111,773

(22) Filed: Apr. 22, 2005

(51) Int. Cl. G06F 13/00

(52) U.S. Cl. 710/100

(57) ABSTRACT

A control system with computer based host includes a first device, a computer based host is electrically connected to the first device. And a second device is electrically connected to the computer based host, wherein the first device has a control right to utilize said second device.

### BACKGROUND OF THE INVENTION

1. Field of the Invention

The present invention generally relates to a control system and more particularly to a method and a system with two hosts.

2. Description of the Prior Art

Nowadays the wireless communication is more and more popular in the world. The typical wireless network system includes an access point (AP), which refer to a point of access to a network, and a network interface card (NIC) or saying PC wireless card. As technology has been improved, the PC wireless card is integrated in a chip or chip set and further combined into the motherboard.

FIG. 1 shows a conventional computer system within a wireless chip. The motherboard 10 includes the WLAN chip 103, which works as PC wireless local area network (WLAN) card. The WLAN chip 103 transmits and receives signal by antenna 11 to the access point (AP) 12 and it further processes data through the PCI bus 102 to a south bridge 101, which is part of a core of a PC. The south bridge 101 also includes a 10/100 MAC layer (not shown) and the 10/100 PHY layer (not shown), which is for communicating other local area network (LAN) by wire.

In wireless communication system, a medium, access point (AP), is needed for one computer communicating with other computers. However, there is no AP and NIC work combined together. Despite software can simulate AP through the WLAN card for communicating two computers, the software has itself inherent disadvantage. The software AP cannot work when the operation system entering standby or sleeping mode. Furthermore, the extension card on the motherboard relies on the motherboard's power. And any extension card on the motherboard cannot work when the computer entering standby or sleeping mode.

Furthermore, any other host cannot control the client in an original circuit, if the original host enters in the sleeping mode or similar mode, for instance: the extension card, AP, has a host and it is going to be a host to control the WLAN client. However, the original host, south bridge, may enter in the sleeping mode or similar mode, and the extension card, AP, cannot control the WLAN client. The similar disadvantage occurs in other host to control a client originally controlled by an original host. For example: a MP3 player controls a built-in CD recorder through a computer system, a digital camera controls a printer through a computer.

As previously mentioned that the disadvantage of control system it is needed a new system to overcome the disadvantage of the prior art.

### SUMMARY OF THE INVENTION

In view of the above discussion, it is an object of the present invention to provide a control system within computer based host.

It is another object of the present invention to implement a physical system by providing a bus for connecting the external circuit device and the computer based host.

A further object of the present invention is to provide power for external circuit device. The power is to ensure the external circuit device working properly and not to effect by the main board.

In short, a control system within computer based host includes a first device, a computer based host is electrically connected to the first device. And a second device is electrically connected to the computer based host, wherein the first device has a control right to utilize said second device. The system further includes the MII bus to connect the first circuit board and the second circuit board and it further includes an AUX power that provides the second circuit board power.

### BRIEF DESCRIPTION OF THE DRAWINGS

FIG. 1 shows a conventional PC wireless communication structure;

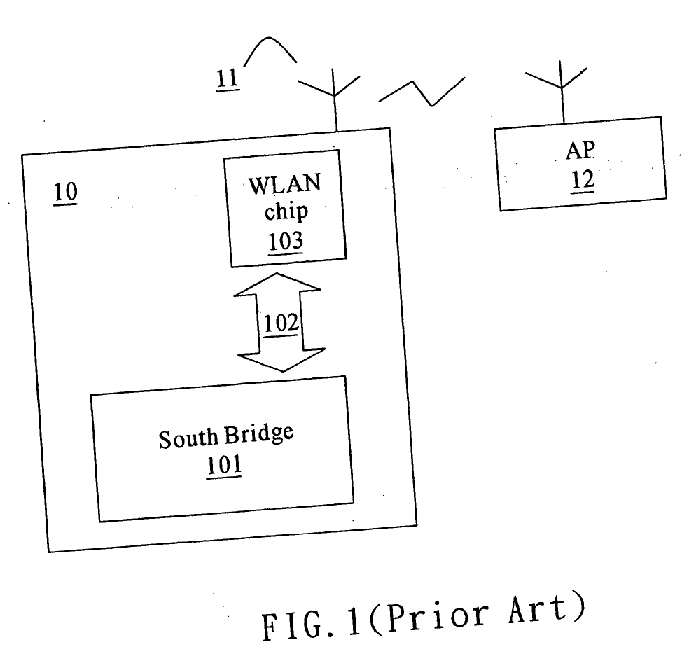

FIG. 2 shows a schematic block diagram illustrating an embodiment of the invention.

FIG. 3 shows a schematic block diagram illustrating another embodiment of the invention;

FIG. 4 shows a schematic block diagram illustrating an embodiment of the access point (AP) utilizing the network client;

FIG. 5 shows a schematic block diagram illustrating an embodiment of the MP3 player utilizing the internal CD recorder;

FIG. 6 shows a schematic block diagram illustrating an embodiment of the MP3 player utilizing the external DVD recorder; and

FIG. 7 shows a schematic block diagram illustrating an embodiment of the digital camera utilizing the printer.

### DESCRIPTION OF THE PREFERRED EMBODIMENTS

Some of the embodiments of the invention will describe in detail and clearly as follows. However, except for the detailed description, the invention can widely apply in others. And the invention is not limited here but the claims.

Otherwise, for easily understanding and clarifying the invention, the parts of the illustration does not depict in corresponding scale. Some scales and related ratio has been exaggerated, and the unrelated parts have not fully shown for the concise drawing.

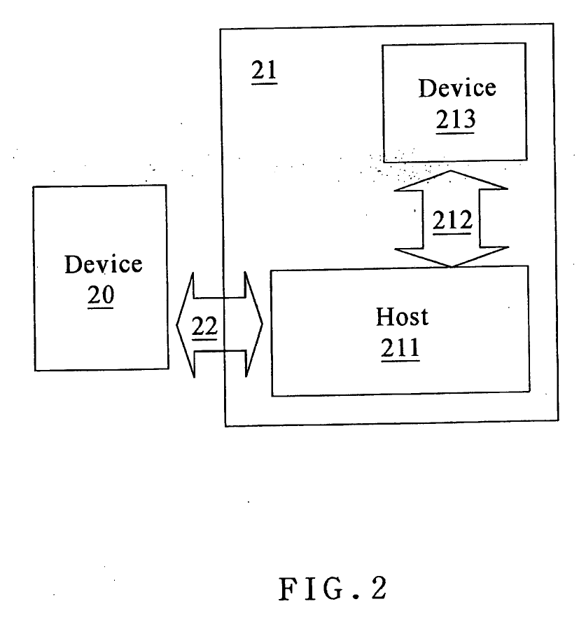

Reference is now briefly made to FIG. 2, illustrating one example of system of the present invention. The computer system 21 includes the host 211 and the device 213. The host 211 can be the south bridge, the north bridge, the central processing unit (CPU) or combined thereof. The host 211 is electrically connected to the device 213 by any bus 212, such as: PCI (Peripheral Component Interconnect) bus, mini PCI bus, ISA (Industry Standard Architecture) bus or Universal Serial Bus (USB). The host 211 is also capable of controlling the device 213. The device 213 can be a chip, a chip set, a module or an apparatus, such as wire network client chip, wireless network client chip set, wire network client chip, or embedded CD player, CD recorder, DVD player, DVD recorder etc. Next, the host 211 is electrically connected to device 20 by the bus 22. The bus 22 can be any bus such as: PCI bus, mini PCI bus, ISA bus, MII bus, USB etc. The device 20 is worked as second host to utilize the device 213. In other words, the device 20 has a control right for the device 213. For example: the device 20 can be an access point (AP) has a control right to control wireless network client, MP3 player has a control right to control CD recorder or DVD player etc.

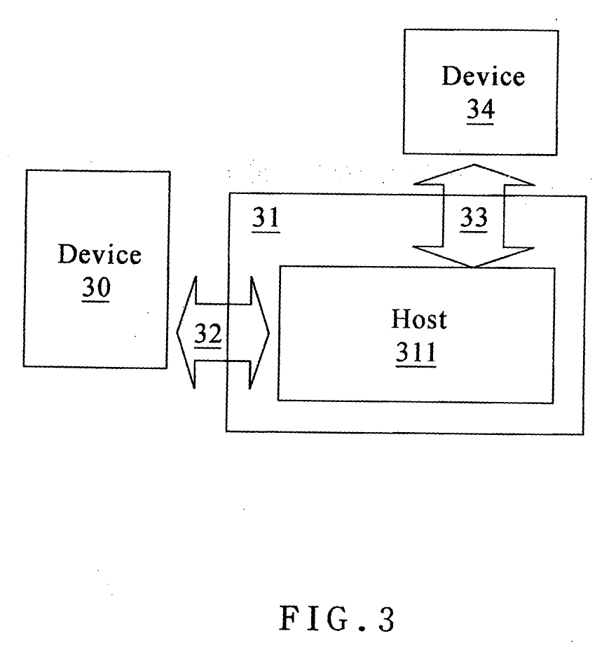

Reference is now briefly made to FIG. 3, illustrating another example of system of the present invention. The computer system 31 includes the host 311. The host 311 describes as the previously mentioned host 211 (FIG. 2) and the host 311 is electrically connected to the device 34 by bus 33. The bus 33 can be any bus such as: PCI bus, mini PCI bus, ISA bus, MII bus, USB etc. The device 34 can be a module or an apparatus, such as wire network client card, wireless network client card, wire network client card, or CD player, CD recorder, DVD player, DVD recorder etc. Next, the host 311 is electrically connected to device 30 by the bus 32. The bus 32 can be any bus such as: PCI bus, mini PCI bus, ISA bus, MII bus, USB etc. The device 30 is worked as second host to utilize the device 34. In other words, the device 30 has a control right for the device 34. For example: the device 30 can be an access point (AP) has a control right to control wireless network client, MP3 player has a control right to control external CD recorder or DVD player, digital camera has a control right to control printer etc.

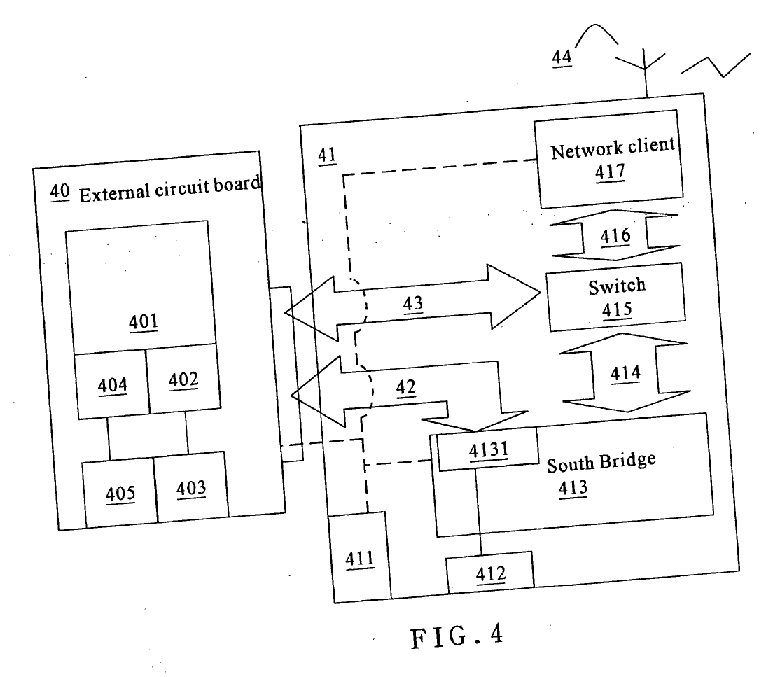

FIG. 4 shows a schematic block diagram illustrating a computer system within wireless host. The circuit board 41 includes a network client 417 and a host 413. The circuit board 41 in the embodiment can be called the motherboard. The network client 417 in one embodiment is wireless client chip. The network client is further electrically connected to an antenna 44. However, it is not limited. The network client 417 can be any client for the host 413, such as: network client chip or chip set. And it can be the wireless network client including Broadcom™, Atheros™, Conexant™ or SiS™ made chip and etc. Or it can be the wire network client including Bbroadcom™, Marvel™, or SiS™ made chip and etc. The network client 417 is electrically connected to the host 413. The host 413 plays a role as a master to control the network client 417. Any kind of chip or chip set being capable of controlling the network client 417 will be the host 413. The example herein, the host 413 is a computer based host and the host 413 can be a south bridge for example: Intel™, VIA™, or SiS™ made chips and etc. It is noted that for the personal computer (PC) system, the central processing unit (CPU), the north bridge and the south bridge are also the core of the system. Which means the host 413 is not limited to the south bridge, but it can further include the CPU and the north bridge for the PC system. The host 413 has a MAC (Media Access Control) layer 4131 and it is electrically connected to a PHY (Physical) layer 412. In one embodiment, the MAC layer 4131 and the PHY layer 412 are complied with Ethernet protocol, for example: the MAC layer 4131 can be the 10,100, 1 G or advanced switched MAC layer and it is corresponding to the 10,100, 1 G or advanced switched PHY layer for the PHY 412 layer.

The external circuit board 40 is a circuit board and in one embodiment, it can be circuit board or a device. The external circuit board 40 in one embodiment is an extension card with a host. The extension card has an interface, for example: ISA interface, PCI interface, PCMCIA (Personal Computer Memory Card International Association) interface, USB (Universal Serial Bus) interface, however, this is not limited. The external circuit board 40 includes a host 401, which is capable of controlling the network client 417. The host 401 in one embodiment can be called second host or related host. For example, the host 401 can be a network processing unit (NPU), if the network client 417 is wireless client or wire client of the network. It is noted that the host 401 and the network client 417 are related. For instance: If the network client 417 is wireless client, the host 401 will be the wireless functioned NPU and the external circuit board 40 will work as AP. If the network client 417 is wire client, the host 401 will be the wire functioned NPU and the external circuit board 40 will work as Hub. The host 401 further includes MAC layer 402 and 404 and they are electrically connected to PHY layer 403 and 405, respectively. In one embodiment, the MAC layer 402 and the PHY layer 403 are complied with Ethernet protocol, for example: the MAC layer 402 is the 10, 100, 1 G or advanced MAC layer and it is corresponding to the 10, 100, 1 G or advanced PHY layer for the PHY layer 403. Similarly, the MAC layer 404 can be the 10, 100, 1 G or advanced MAC layer and the PHY layer 405 is corresponding to the 10, 100, 1 G or advanced PHY layer. It is noted that the MAC layer 402, 404 and the PHY layer 403, 405 are not limited. The amount of the MAC layer and PHY layer is upgradeable for example: in one embodiment it can be two ports but in other embodiment it can be four ports, eight ports or more.

Observing FIG. 4 again, in the embodiment, the host 401 is electrically connected to the host 413 via the MII bus 42. The MII bus 42 is an industry standard bus and provides a serial interface. The MII bus 42 also provides a way for data exchanging. And as the MII bus used, there is no PHY layer needed between the host 401 and the host 413. Moreover, the host 401 controls the network client 417 further via the standard bus 43 and 416. In one embodiment, the bus 43, 414 and 416 are PCI bus; however, it is not limited. The mini-PCI bus, the ISA bus, and the USB also do as well as the PCI bus. Regarding FIG. 4, the switch 415 is needed if the bus 43, 414 and 416 are connected together. However, the switch 415 can be performed by hardware and also can be performed by software. The following description will place the switch 415 in hardware. At first, the external circuit board 40 has not been connected to the circuit board 41. The switch 415 is connected between the bus 414 and the bus 416. As the result, the host 413 by bus 414 and bus 416 can successfully control the network client 417. The next, the external circuit board 40 is electrically connected to the circuit board 41 and the switch 415 is connected between the bus 43 and the bus 416; meanwhile the connecting between the bus 414 and bus 416 breaks. As the result, the host 401 controls the network client 417. Although the host 413 cannot directly control the network client 417, the host 413 can utilize the function of the network client 417 by the external circuit board 40 wherein the MII bus 42 provides a MAC layer for data exchanging between the host 413 and the host 401.

Regarding FIG. 4 again, the power 411 provides an AUX (auxiliary) power for the host 413, the network client 417 and the external circuit board 40. In the PC system, the AUX power is worked when system in sleeping or standby status. Normally the AUX power is used to wait a signal to wake up the PC. The invention provides an AUX power to the external circuit board 40 and it ensures that the external circuit board 40 is worked when the circuit board 41 is entered to power down. In the embodiment of the FIG. 4, the operation is that the external circuit board 40 is worked as host to utilize the network client 417. When other computers (not shown) want to communicate with the invention computer through wireless, the signal goes through antenna 44 controlled by network client 417 and then via bus 416 and bus 43 to the external circuit board 40. The external circuit board 40 according to the signal transmits signal to the host 413 by bus 42.

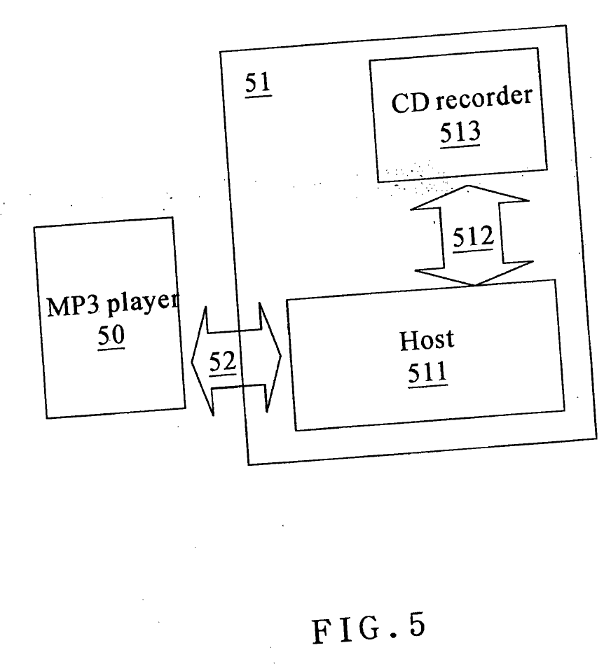

FIG. 5 shows one embodiment of the present invention. The computer system 51 includes the host 511 and the CD recorder 513. The host 511 describes as the previously mentioned host 211 (FIG. 2) and in the embodiment, the host 511 is the core of the PC system. And normally the host 511 includes the sough bridge, the north bridge, and the CPU and it is electrically connected to the CD recorder 513 by the bus 512. The bus 212 in the embodiment is PCI bus. It is understood that the host 511 is capable of controlling the CD recorder 513 by PCI bus. Next, the host 511 is electrically connected to the MP3 player 50 by the bus 52. The bus 52 in the embodiment is USB bus. The MP3 player 50 is worked as second host to utilize the CD recorder 513. In other words, the MP3 player 50 has a control right for the CD recorder 513.

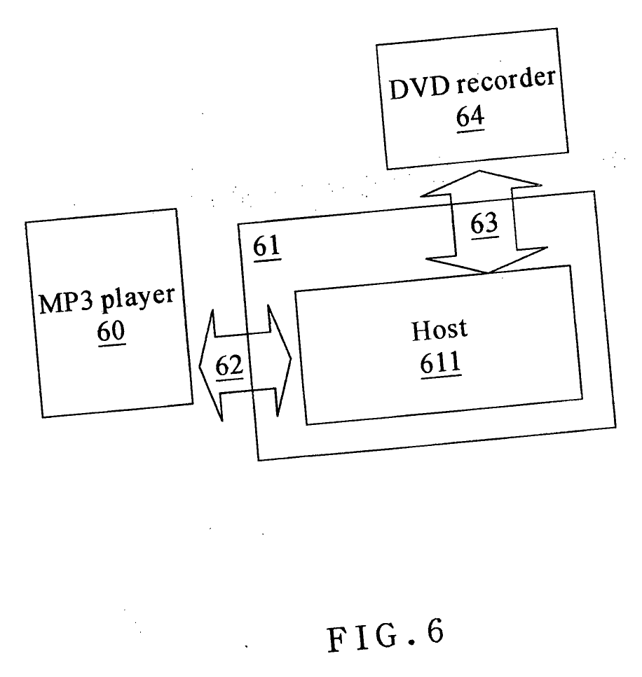

FIG. 6 shows another embodiment of the present invention. The computer system 61 includes the host 611. The host 611 describes as the previously mentioned host 211 (FIG. 2) and in the embodiment, the host 611 is the core of the PC system. And normally the host 511 includes the south bridge, the north bridge, and the CPU and it is electrically connected to the DVD recorder 64 by the bus 63. The bus 63 in the embodiment is USB bus. It is believe that the host 611 is capable of controlling the DVD reocrder 64 by USB bus. Next, the host 611 is electrically connected to the MP3 player 60 by the bus 62. The bus 62 in the embodiment is USB bus. The MP3 player 60 is worked as second host to utilize the DVD recorder 64. In other words, the MP3 player 60 has a control right for the DVD recorder 64.

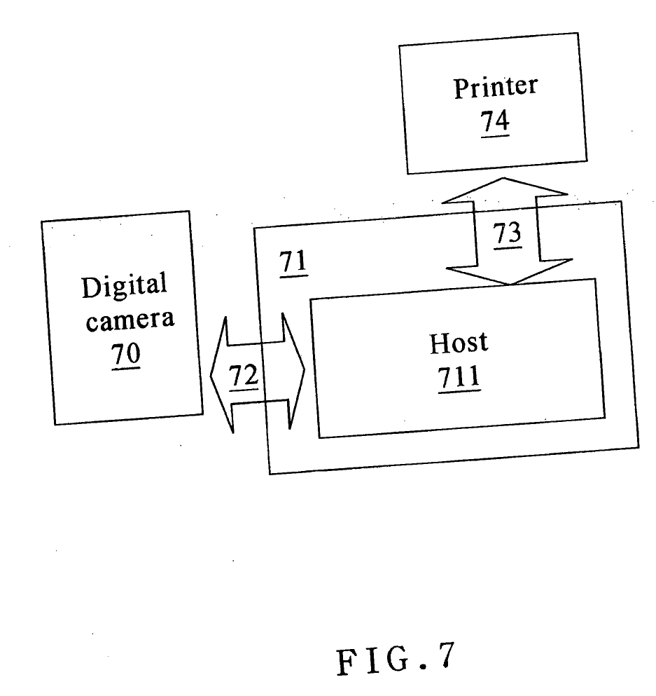

FIG. 7 shows another embodiment of the present invention. The computer system 71 includes the host 711. The host 711 describes as the previously mentioned host 211 (FIG. 2) and in the embodiment, the host 711 is the core of the PC system. And normally the host 511 includes the south bridge, the north bridge, and the CPU and it is electrically connected to the printer 74 by the bus 73. The bus 73 in the embodiment is parallel bus. It is believe that the host 711 is capable of controlling the printer 74 by the parallel bus. Next, the host 711 is electrically connected to the digital camera 70 by the bus 72. The bus 72 in the embodiment is USB bus. The digital camera 70 is worked as second host to utilize the printer 74. In other words, the digital camera 70 has a control right for the printer 74.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A control system comprising:
a first device;
a first host being electrically connected to said first device; and
a second device being electrically connected to said first host,
wherein said first device has a control right to utilize said second device.

2. The control system according to claim 1, wherein said first host and said second device on the same circuit board.

3. The control system according to claim 1, wherein said first device is a circuit with Access Point (AP) function and said second device is a circuit with wireless client function.

4. The control system according to claim 1, further comprising a PCI bus wherein said PCI bus connects said first device and said second device.

5. The control system according to claim 4, wherein said first host is electrically connected to said first device by MII bus.

6. The control system according to claim 1, further comprising an AUX power wherein said AUX power is electrically connected to said first device and said second device.

7. The control system according to claim 6; wherein said first host comprise a south bridge.

8. A method for a control system comprising
connecting a first host and a second device, wherein said first host has a control right to utilize said second device; and
connecting a first device and said first host, wherein said first host releases said control right and said first device gets said control right to utilize said second device.

9. The control system according to claim 8, wherein said connecting said first host and said second device is by PCI bus.

10. The control system according to claim 8, further comprising the step of connecting said first device and said second device by PCI bus.

11. The control system according to claim 10, wherein said connecting said first device and said first host is by MII bus.

12. The control system according to claim 8, further comprising the step of providing an AUX power and connecting said first device and said second device to said AUX power.

13. A control system comprising:
a first device having a network host;
a computer based host being electrically connected to said first device; and
a second device having a network client and being electrically connected to said computer based host,
wherein said network host of said first device has a control right to utilize said network client of said second device.

14. The control system according to claim 13, wherein said first device is Access Point (AP) card.

15. The control system according to claim 14, wherein said AP card has a network processing unit (NPU).

16. The control system according to claim 13, wherein said AP card has 10/100 MAC layer and 10/100 PHY layer being complied with Ethernet protocol.

17. The control system according to claim 16, wherein said 10/100 MAC layer and 10/100 PHY layer are upgradeable.

18. The control system according to claim 13, wherein said computer based host is south bridge.

19. The control system according to claim 13, wherein said computer based host being connected to said first device by MII bus.

20. The control system according to claim 13, further comprising an AUX power wherein said AUX power is electrically connected to said first device and said second device.
